(19) United States
(12) Patent Application Publication
(10) Pub. No.: US 2002/0015089 A1
(43) Pub. Date: Feb. 7, 2002

(54) Solid scanning optical writing device and driving method for said device

(76) Inventor: Tatsuya Kanazawa, Sakai-shi (JP)

Correspondence Address: SIDLEY AUSTIN BROWN & WOOD, 717 NORTH HARWOOD, SUITE 3400, DALLAS, TX, 75201, US

(21) Appl. No.: 09/497,650

(22) Filed: Feb. 3, 2000

(30) Foreign Application Priority Data
Feb. 5, 1999 (JP) 11-029309

(51) Int. Cl. B41J 2/47

(52) U.S. Cl. 347/239

(57) ABSTRACT

A solid scanning optical writing device writes images using PLZT light shutters, having an electro-optical effect. A PLZT light shutter exhibits hysterisis. If the PLZT light shutter is driven for a long time, the optimal drive voltage for the shutter changes. Therefore, when the cumulative drive time reaches a predetermined time period, the solid scanning optical writing device adjusts the drive voltage based on the light amount output from the light shutter.

This application is based on application No. 11-29309 filed in Japan, the contents of which is hereby incorporated by reference.

### BACKGROUND OF THE INVENTION

1. Field of the Invention

The present invention pertains to a solid scanning optical writing device that writes images using light modulating elements having an electro-optical effect and to the driving method for this solid scanning optical writing device.

2. Description of the Related Art

Various optical writing devices have conventionally been provided that perform ON/OFF control of light for each pixel using a light shutter array comprising PLZT light shutters in order to form an image (latent image) on photographic paper using a silver halide material or on film or an electrophotographic photoreceptor.

Incidentally, a PLZT light shutter, which is a light modulating element having an electro-optical effect, exhibits hysterisis, i.e., if modulation is performed for a long time by means of the PLZT light shutter, the optimal drive voltage for the light shutter changes. Therefore, when using a light shutter array comprising multiple PLZT light shutters, if drawing of part of an image is performed for a long time and then drawing of the entire image is performed using the initial drive voltage, the output light amount from the PLZT light shutters used for the first image draw, which took a long time, decreases, resulting in the problem of unevenness in light amount between the long-time image draw area and the shorter-time image draw area.

### OBJECTS AND SUMMARY

In view of the situation described above, the object of the present invention is to provide an improved solid scanning optical writing device and a driving method for said device.

Another object of the present invention is to provide a solid scanning optical writing device and a drive method for said device that can reduce the unevenness in light amount caused by the hysterisis exhibited by the light modulating elements.

In order to attain these and other objects, one aspect of the present invention comprises a solid scanning optical writing device that includes multiple light modulating elements having an electro-optical effect, light modulating element drive circuits that can adjust the drive voltage impressed to the light modulating elements, a light amount sensor that measures the output light amount from the light modulating elements, and a timer that measures the cumulative drive time of the light modulating elements. In this solid scanning optical writing device, when the cumulative drive time reaches a prescribed period, the light amount sensor measures the output light amount from the light modulating element, so that the drive voltage from the drive circuit for that light modulating element may be adjusted based on the measured output light amount. Alternatively, in place of the timer to measure the cumulative drive time of the light modulating elements, a timer that measures the time that has elapsed from the start-up of the device or an instructing device that instructs the light amount sensor to perform the measuring operation may be used.

Therefore, the drive voltage for the light modulating elements is appropriately adjusted such that the light modulating elements are driven with the optimal or near-optimal drive voltage at all times. Consequently, high quality images having little unevenness in light amount may be formed.

### BRIEF DESCRIPTION OF THE DRAWINGS

These and other objects and features of the present invention will become apparent from the following description of preferred embodiments thereof taken in conjunction with the accompanying drawings, in which:

FIG. 1 is a perspective view of an optical writing device;

FIG. 2 is a plan view showing the basic construction of a light amount measuring device;

FIG. 3 is a block diagram showing the construction of the control unit of the optical writing device;

FIG. 4 shows the hysterisis of a light shutter chip;

FIG. 5 is a graph showing the relationships among the drive period, drive voltage and output light amount when drive voltage adjustment is performed;

FIG. 6 is a flow chart showing a first example of the control procedure for the drive voltage adjustment;

FIG. 7 is a flow chart showing a second example of the control procedure for the drive voltage adjustment;

FIG. 8 is a flow chart showing a third example of the control procedure for the drive voltage adjustment; and

FIG. 9 shows a color printer in which the optical writing device is mounted.

In the following description, like parts are designated by like reference numbers throughout the several drawing.

### DETAILED DESCRIPTION OF THE PREFERRED EMBODIMENTS

The solid scanning optical writing device is explained below with reference to the accompanying drawings.

Optical writing head

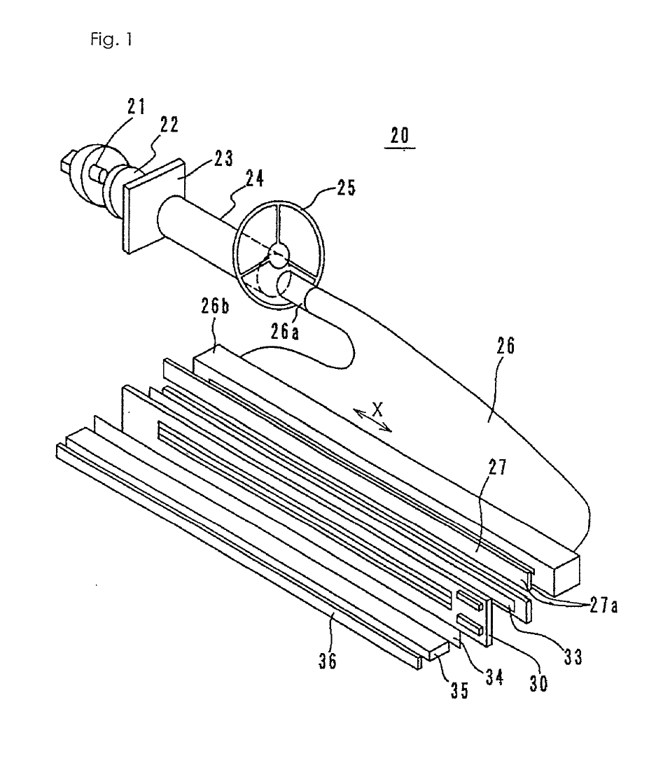

FIG. 1 shows an optical writing head 20 to write color images on photographic paper using a silver halide material. This optical writing head 20 essentially comprises a halogen lamp 21, a heatproof filter 22, a color correction filter 23, a diffusion cylinder 24, an RGB filter 25, an optical fiber array 26, a slit plate 27, a light shutter module 30, an image forming lens array 35 and a dustproof glass panel 36.

The light emitted from the halogen lamp 21 is deprived of heat by the heatproof filter 22 and is adjusted by the color correction filter 23 such that the light quality may match the spectral-response characteristic of the photographic paper. The diffusion cylinder 24 improves the light use efficiency and reduces the unevenness in light amount. The RGB filter 25 is driven to rotate in synchronization with the writing by means of the light shutter module 30, which is described below, and changes the color of the passing light for each line.

The optical fiber array 26 comprises a large number of optical fibers. The ends 26a are bound together and face the diffusion cylinder 24 via the RGB filter 25. The other ends 26b are aligned in the main scanning directions indicated by the two-headed arrow X and emit light in a linear fashion. The slit surfaces 27a of the slit plate 27 have a smooth finish to lead the light emitted from the optical fiber array 26 to the light shutter module 30 efficiently. The slit plate 27 also has a heater (not shown in the drawing) to maintain the PLZT shutter chips at a constant temperature, and temperature control is performed based on the detection results from a temperature detecting element (not shown in the drawing) mounted on the module 30.

The light shutter module 30 comprises multiple light shutter chips, which comprise PLZT shutters, aligned to form an array in a slit opening in a ceramic substrate or in a glass substrate, and driver ICs mounted along the array. Only those light shutters of the light shutter chips that correspond to prescribed pixels are driven by means of the driver ICs. A polarizer 33 and an analyzer 34 are mounted in the front and back of the module 30, respectively. PLZT is a ceramic material having a light permeability with a large Kerr constant electro-optical effect, as is well known, and the light that was polarized to be straight light by the polarizer 33 undergoes rotation of the plane of polarization due to the turning ON or OFF of an electric field generated based on the impression of voltage to the light shutters, whereupon the light emitted from the analyzer 34 is turned ON or OFF.

The light emitted through the analyzer 34 passes through the image forming lens array 35 and the dustproof glass panel 36 and forms an image on the photographic paper, forming a latent image. The photographic paper is conveyed at a constant speed in a direction perpendicular to the main scanning directions X (the secondary scanning direction).

In the optical writing head 20, due to the construction of the driver IC and of the substrate circuit of the light shutter module 30, each light shutter is impressed with the same level of drive voltage, or the light shutters connected to the same IC (one IC has multiple drive pads) or the light shutters connected to several ICs are impressed with the same level of drive voltage.

Light amount measuring device and drive voltage adjusting method

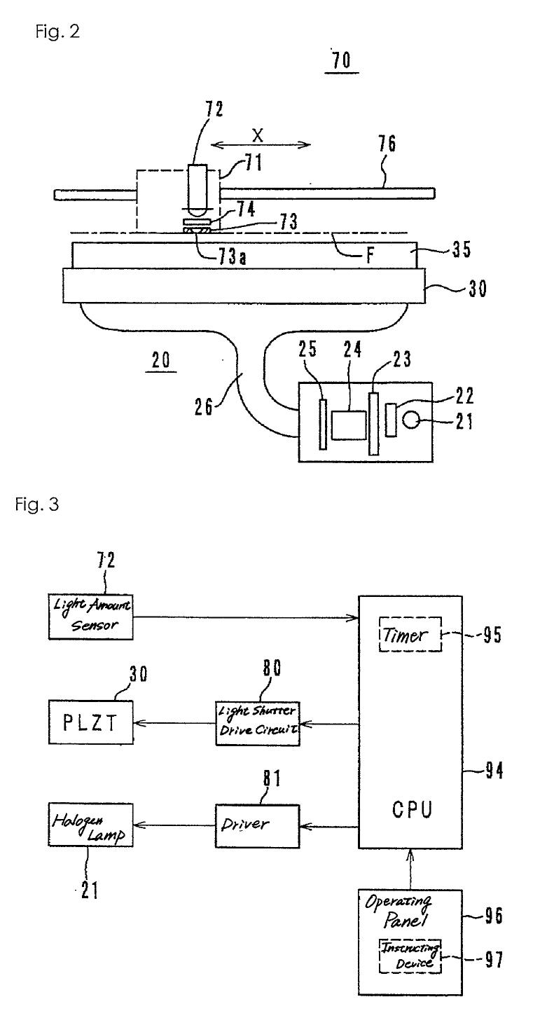

FIG. 2 shows a measuring device 70 that measures the light amount of each light shutter chip of the optical writing head 20.

This measuring device 70 comprises a measuring unit 71 having a light amount sensor 72, which is mounted to a guide rod 76, such that the measuring unit may slide along the guide rod. The guide rod 76 is located parallel to the main scanning directions of the light shutter module 30 (the directions of the two-headed arrow X), so that the measuring unit 71 moves forward and backward at a constant speed in the directions of the two-headed arrow X while the light amount sensor 72 is positioned immediately above the light shutter chips.

A slit plate 73 and a light diffusion plate 74 are located on the light entry side of the light sensor 72. The slit plate 73 has a slit 73a and is located on the focusing plate F of the image forming lens array 35. For the light amount sensor 72, a sensor having a range of spectral-response characteristic that is equal to or larger than the recording medium is used.

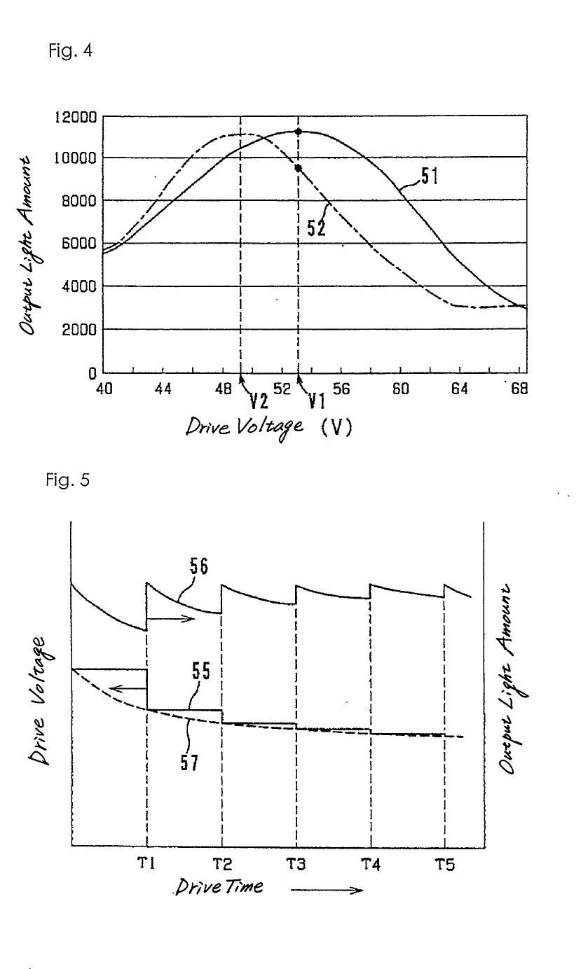

The light amount measuring device 70 and optical writing head 20 having the construction described above are controlled by a microcomputer, so that the timing of the drive voltage adjustment for the light shutter chips is controlled. FIG. 3 shows the construction of the control unit. The internal timer 95 of the microcomputer (CPU) 94 measures the cumulative drive period for the light shutters or the elapsed time from the start-up of the device. In general, when a PLZT light shutter chip is driven to perform light modulation for a long time, as shown in FIG. 4 for example, the optimal drive voltage for the light shutter chip changes and the output light amount characteristic changes from the initial curved line 51 to the curved line 52. Therefore, the output light amount from the light shutter chips that are still driven with the initial drive voltage V1 declines. Consequently, based on the signal from this timer 95 or the instructing device 97 located on the operating panel 96, a light shutter drive voltage adjustment control signal is issued from the CPU 94. The instructing device 97 is manually operable.

After flashing the halogen lamp 21 by means of the driver 81, the light amount sensor 72 is moved forward from the initial position outside the scanning area of the light shutter array. A drive voltage is sequentially impressed to each light shutter chip from the light shutter drive circuit 80 to turn on the light shutter chips. The light amount sensor 72 measures the output light amount from the light shutter chips that are ON and inputs the measurement results into the CPU 94.

The output light amount values input to the CPU 94 are ordinarily smaller than the initial amount. Therefore, based on the difference between the output amount thus input and the initial amount, the drive voltage for the light shutter chip is adjusted from V1 to V2 by the CPU 94. In the same way, the drive voltage for the remaining PLZT light shutter chips is sequentially adjusted. When the light amount sensor 72 has been moved over a distance slightly longer than the main scanning length, the light shutter chip drive voltage adjustment is completed by the CPU 94 and the light amount sensor 72 is moved back to the initial position. The drive voltage adjustment for all of the light shutter chips is completed in this way.

FIG. 5 is a graph that shows the drive voltage (see the solid line 55) and the output light amount (see the solid line 56) when light shutter chip drive voltage adjustment is performed each time a certain cumulative time is exceeded when the drive time measured by the timer 95 is accumulated. As shown by the dotted line 57, as the drive time increases, the fluctuation of the optimal drive voltage decreases, and therefore, the range of drive range adjustment also decreases as the drive time increases.

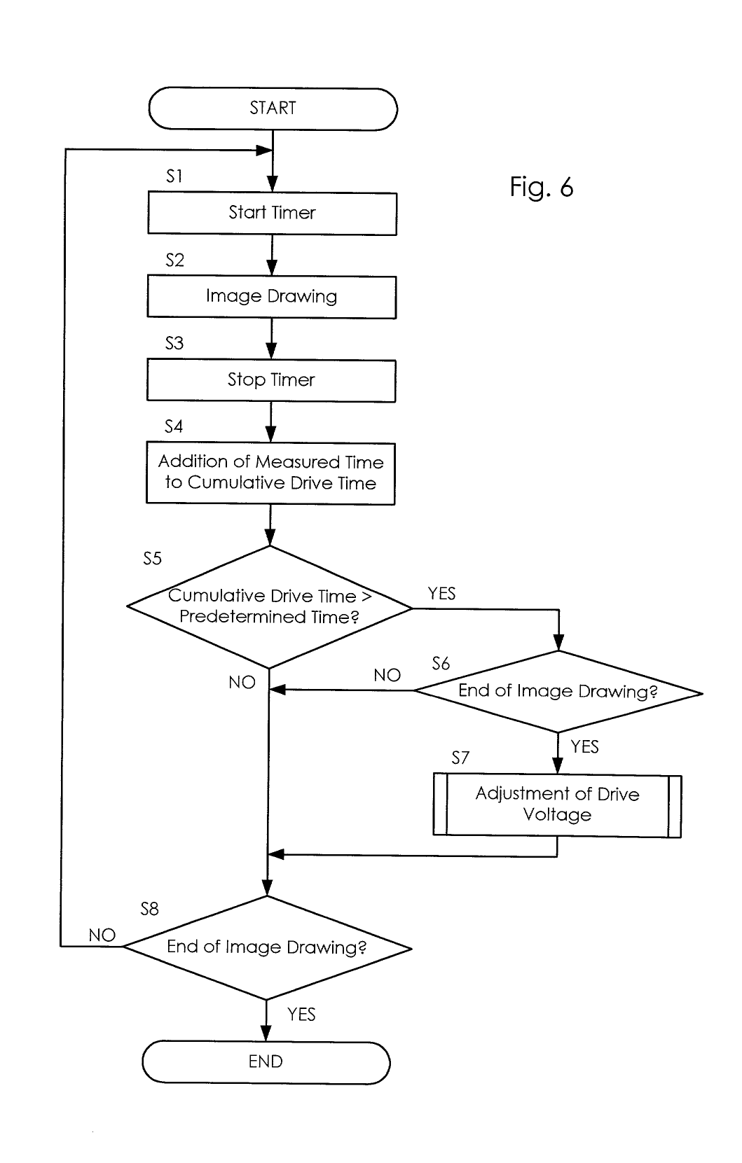

A first example of the drive voltage adjustment control procedure will now be explained with reference to FIG. 6. The drive voltage adjustment control routine of the first example is implemented when the light shutters formed on the light shutter chip begin to be driven. First when a signal indicating the commencement of image draw is received, the timer that measures the cumulative drive time of the light shutters is turned ON in step S1. The light shutters are driven in step S2 to perform image draw. When the driving of the light shutters is finished in step S3, the timer is turned OFF.

The drive time measured by the timer in step S4 is then added to the cumulative drive time stored in the memory of the CPU 94. It is determined in step S5 whether or not the cumulative drive time has reached a pre-set level, and if it has not reached it, the CPU 94 proceeds to step S8, in which it is determined whether or not all image draw is finished. If all image draw is not finished, the CPU 94 returns to step S1.

On the other hand, if it is determined in step S5 that the cumulative drive time has reached the pre-set level, it is determined in step S6 whether or not all image draw is finished. If all image draw is finished, the CPU 94 proceeds to step S8 after performing the drive voltage adjustment in step S7. Where it is determined in step S6 that all image draw is not finished, the CPU 94 proceeds to step S8.

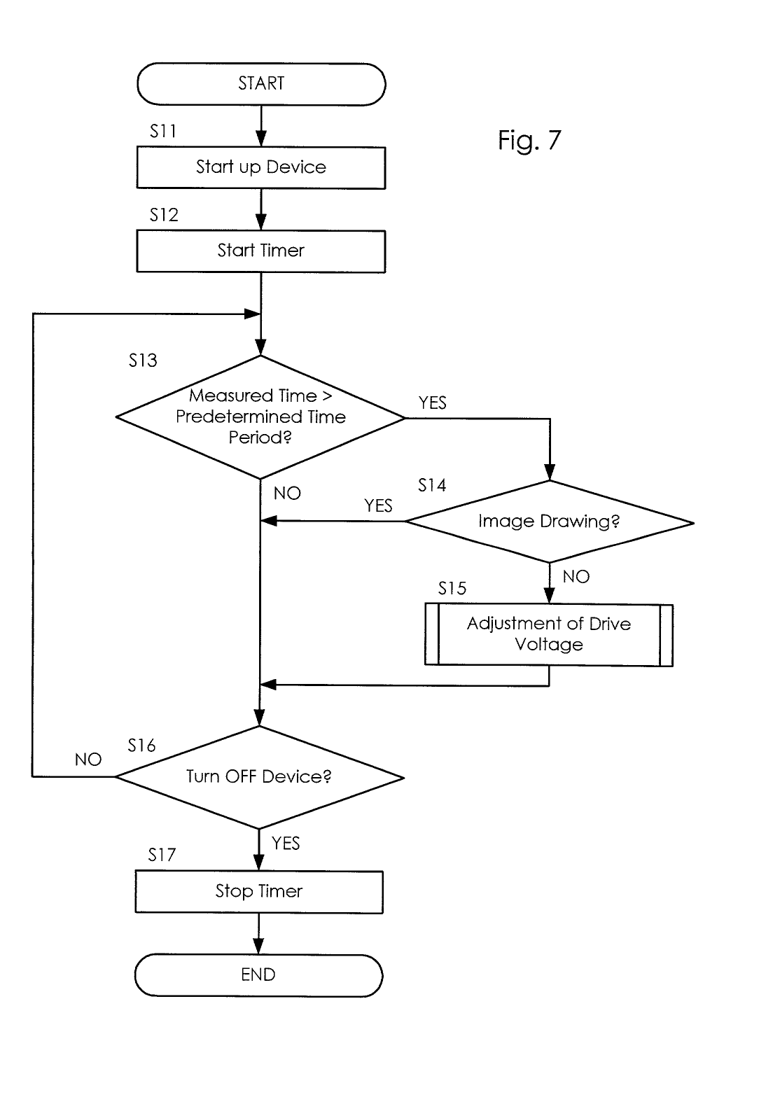

A second example of the drive voltage adjustment control procedure will now be explained with reference to FIG. 7. In the drive voltage adjustment control routine of the second example, the timer is turned ON in step S12 after power is turned ON to start up the device in step S11. The timer measures the elapsed time from the start-up of the device regardless of the drive time of the light shutters, and it is determined in step S13 whether or not the elapsed time has reached a pre-set level. If it is determined that it has reached the pre-set level, it is determined in step S14 whether or not the light shutters are performing a modulation operation, i.e., whether or not they are performing image draw. If they are not performing image draw, the CPU 94 proceeds to step S16 after performing drive voltage adjustment in step S15. If the light shutters are performing image draw in step S14, the CPU 94 proceeds to step S16.

On the other hand, if it is determined in step S13 that the elapsed time has not reached the pre-set level, it is determined in step S16 whether or not the device is turned OFF. If it is turned OFF, the timer is turned OFF in step S17, and if the device is not turned OFF, the CPU 94 returns to step S13.

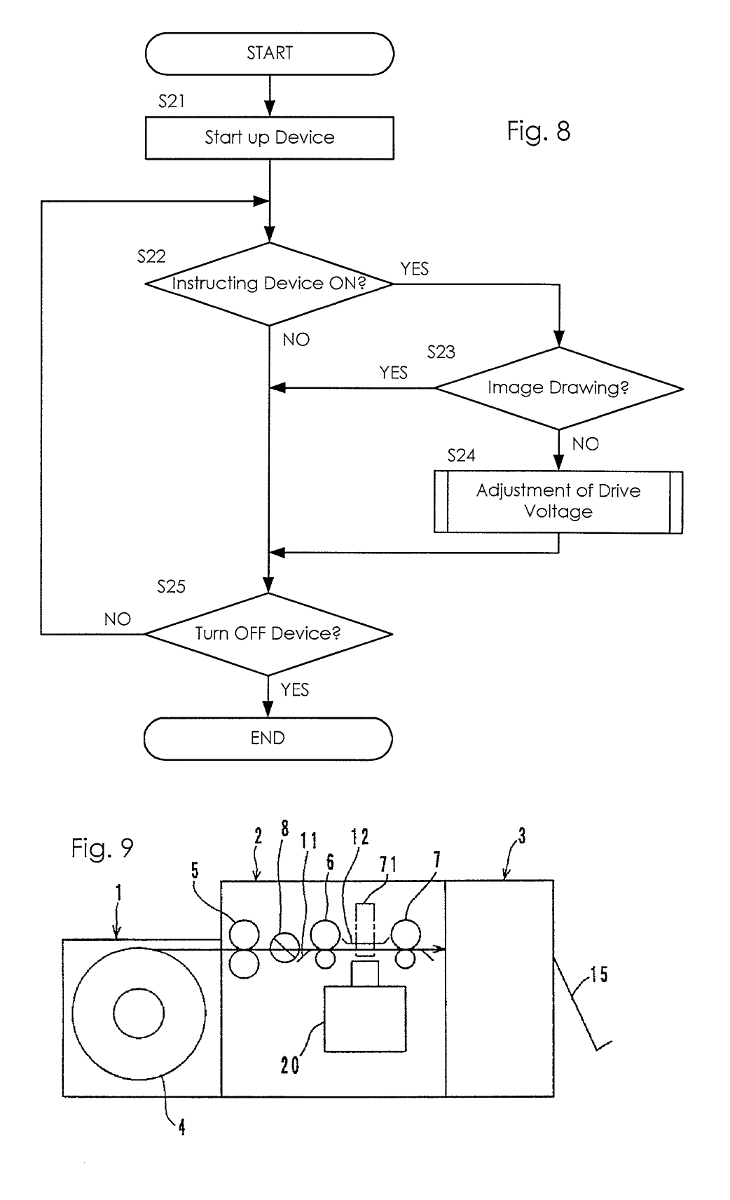

Further, a third example of the drive voltage adjustment control procedure will be explained with reference to FIG. 8. The drive voltage adjustment control routine of the third example is implemented at any time. First, after power to the device is turned ON to start up the device in step S21, it is determined in step S22 whether or not the operator turned on the instructing device located on the operation panel. The operator turns ON the instructing device at any given time. If it is determined in step S22 that the instructing device is turned ON, it is determined in step S23 whether or not the light shutters are performing image draw. If they are not performing image darw, the CPU 94 proceeds to step S25 after performing drive voltage adjustment in step S24. If it is determined in step S23 that the light shutters are performing image draw, the CPU 94 proceeds to step S25. On the other hand, if it is determined in step S22 that the instructing device is not turned ON, it is determined in step S25 whether or not the device is turned OFF. If it is not turned OFF, the CPU 94 returns to step S22.

Color printer

FIG. 9 shows the basic construction of a color printer to produce photo prints. This color printer comprises a photographic paper storage unit 1, an image forming unit 2 and a processing unit 3. The photographic paper 4 is stored rolled up in the storage unit 1. In the image forming unit 2 are mounted an optical writing head 20 shown in FIG. 1 and a measuring unit 71 shown in FIG. 2. Further, in the image forming unit 2 are also mounted conveyance roller pairs 5, 6 and 7 for the photographic paper 4, a cutter 8 and a conveyance guide plates 11 and 12.

The photographic paper 4 is guided into the image forming unit 2 from the conveyance roller pair 5 with the photosensitive surface facing downward. When a certain length of the photographic paper 4 has been introduced, the rotation of the roller pair 5 is stopped and the cutter 8 is operated, such that the paper is cut. The cut-off photographic paper piece 4 is conveyed at a constant speed by the roller pairs 6 and 7. When the photographic paper piece 4 passes the optical writing head 20, it is exposed through the opening formed in the guide plate 11, and an image (latent image) is formed on it. The photographic paper piece 4 is developed and dried in the processing unit 3 after exposure, and is then ejected onto the tray 15.

In this color printer, R, B and G images are written by rapidly changing the light source color through the rotation of the RGB filter 25 of the optical writing head 20 and by turning ON/OFF the PLZT light shutters for each line. In this printer, power is turned ON by means of a timer and temperature control for the developer is performed. During this warm-up period, light amount is measured for each light shutter chip and drive voltage adjustment for each light shutter chip is performed based on the measured light amount. After this, light shutter chip drive voltage adjustment is performed again using the control procedure described above (in at least one of the first through third examples).

Using the optical writing device explained above, the light shutter drive voltage is appropriately adjusted so that the light shutters may be driven using the optimal drive voltage or near-optimal drive voltage at all times. Therefore, high quality images having little unevenness in light amount may be formed.

Modifications

The optical writing device pertaining to the present invention is not limited to the embodiments described above, and may be modified in various ways within its essential scope.

In particular, for the solid scanning elements used for optical writing, LCS (liquid crystal shutters), DMD (deformable mirror devices) or FLD (fluorescent devices) may be used in addition to PLZT shutters.

In addition, the present invention may be applied in an image writing device that writes images onto silver halide film or an electrophotographic photoreceptor, or in an image projector that projects images onto a display, as well as in an image writing device that writes images onto photographic paper using a silver halide material.

Although the present invention has been fully described by way of examples with reference to the accompanying drawings, it is to be noted that various changes and modifications will be apparent to those skilled in the art. Therefore, unless such changes and modification depart from the scope of the present invention, they should be construed as being included therein.

What is claimed is:

1. A solid scanning optical writing device comprising:
a light modulating element having an electro-optical effect;
a drive circuit for driving said light modulating element in accordance with image data, said drive circuit being capable of adjusting a drive voltage which is applied to said light modulating element;
a sensor for measuring an output light amount from said light modulating element;
a timer for measuring cumulative drive time of said light modulating element; and
a controller for controlling said drive circuit to adjust the drive voltage based on the output light amount measured by said sensor when the cumulative drive time reaches a prescribed period.

2. A solid scanning optical writing device as claimed in claim 1, wherein said controller delays initiation of the drive voltage adjustment until the completion of the image writing operation in a case where the image writing operation of the light modulating element is being executed when the cumulative drive time reaches a prescribed period.

3. A solid scanning optical writing device as claimed in claim 1, wherein said write modulating element includes a PLZT light shutter.

4. A solid scanning optical writing device comprising:
a light modulating element having an electro-optical effect;
a drive circuit for driving said light modulating element in accordance with image data, said drive circuit being capable of adjusting a drive voltage which is applied to said light modulating element;
a sensor for measuring an output light amount from said light modulating element;
a timer for measuring time that has elapsed from the start-up of the device; and
a controller for controlling said drive circuit to adjust the drive voltage based on the output light amount measured by said sensor when the measured time reaches a prescribed period.

5. A solid scanning optical writing device as claimed in claim 4, wherein said controller delays initiation of the drive voltage adjustment until the completion of the image writing operation in a case where the image writing operation of the light modulating element is being executed when the measured time reaches a prescribed period.

6. A solid scanning optical writing device as claimed in claim 4, wherein said write modulating element includes a PLZT light shutter.

7. A solid scanning optical writing device comprising:
a light modulating element having an electro-optical effect;
a drive circuit for driving said light modulating element in accordance with image data, said drive circuit being capable of adjusting a drive voltage which is applied to said light modulating element;
a sensor for measuring an output light amount from said light modulating element;
a instruction device which is manually operable and issuing an instruction in response to an manual operation; and
a controller for controlling said drive circuit to adjust the drive voltage based on the output light amount measured by said sensor in response to the instruction which is issued from said instruction device.

8. A solid scanning optical writing device as claimed in claim 7, wherein said controller delays initiation of the drive voltage adjustment until the completion of the image writing operation in a case where the image writing operation of the light modulating element is being executed when the instruction is issued from said instruction device.

9. A solid scanning optical writing device as claimed in claim 7, wherein said write modulating element includes a PLZT light shutter.

10. A driving method for driving a solid scanning optical writing device, said driving method comprising steps of
driving a light modulating element, which has an electro-optical effect, in accordance with image data to write an image;
measuring cumulative drive time of the light modulating element;
when the cumulative drive time reaches a prescribed period,
detecting output light amount of said light modulating element; and
adjusting a drive voltage based on the output light amount measured in said detecting step.

11. A drive method as claimed in claim 10, wherein a initiation of said adjusting step is delayed until the completion of the image writing operation in a case where the image writing operation of the light modulating element is being executed when the cumulative drive time reaches a prescribed period.

12. A drive method as claimed in claim 10, wherein said write modulating element includes a PLZT light shutter.

13. A driving method for driving a solid scanning optical writing device, said driving method comprising steps of
driving a light modulating element, which has an electro-optical effect, in accordance with image data to write an image;
measuring time that has elapsed from the start-up of the device;
when the measured time reaches a prescribed period,
detecting output light amount of said light modulating element; and
adjusting a drive voltage based on the output light amount measured in said detecting step.

14. A drive method as claimed in claim 13, wherein a initiation of said adjusting step is delayed until the completion of the image writing operation in a case where the image writing operation of the light modulating element is being executed when the measured time reaches a prescribed period.

15. A drive method as claimed in claim 13, wherein said write modulating element includes a PLZT light shutter.

16. A driving method for driving a solid scanning optical writing device, said driving method comprising steps of
driving a light modulating element, which has an electro-optical effect, in accordance with image data to write an image;
issuing an instruction in response to an manual operation of an operation panel;
detecting output light amount of said light modulating element in response to the instruction; and
adjusting a drive voltage based on the output light amount measured in said detecting step.

17. A drive method as claimed in claim 16, wherein a initiation of said adjusting step is delayed until the completion of the image writing operation in a case where the image writing operation of the light modulating element is being executed when the instruction is issued.

18. A drive method as claimed in claim 16, wherein said write modulating element includes a PLZT light shutter.
